(19) United States
(12) Patent Application Publication
(10) Pub. No.: US 2018/0352226 A1
(43) Pub. Date: Dec. 6, 2018

(54) METHOD AND APPARATUS OF BLOCK PARTITION WITH SMALLEST BLOCK SIZE IN VIDEO CODING

(71) Applicants: Jicheng AN, Beijing City (CN); Kai ZHANG, Beijing (CN); Han HUANG, Beijing (CN)

(72) Inventors: Jicheng AN, Beijing City (CN); Kai ZHANG, Beijing (CN); Han HUANG, Beijing (CN)

(21) Appl. No.: 15/777,417

(22) PCT Filed: Oct. 18, 2016
(86) PCT No.: PCT/CN2016/102359

§ 371 Date: May 18, 2018

(30) Foreign Application Priority Data
Nov. 23, 2015 (CN) PCT/CN2015/095283

(51) Int. Cl. H04N 19/119; H04N 19/107; H04N 19/12

(52) U.S. Cl. CPC H04N 19/119; H04N 19/12; H04N 19/107

(57) ABSTRACT

A method and apparatus of block partition for prediction process or transform process in video coding are disclosed. Whether a smallest allowed block size smaller than 4 is allowed is determined and information related to the decision is signalled in SPS (sequence parameter set), PPS (picture parameter set) or slice header regarding. If the smallest allowed block size smaller than 4 is allowed, the current block is partitioned into one or more sub-blocks using a block size set including the smallest allowed block size. The smallest allowed block size is 2 in one embodiment. According to another method, a threshold area is determined and transform skip mode is applied to the current block if the current block area of the current block is equal to or smaller than the threshold area.

### CROSS REFERENCE TO RELATED APPLICATIONS

The present invention claims priority to PCT Patent Application, Ser. No. PCT/CN2015/095283, filed on Nov. 23, 2015. The PCT Patent Application is hereby incorporated by reference in its entirety.

### TECHNICAL FIELD

The invention relates generally to video processing. In particular, the present invention relates to block partition for prediction or transform with constraints on smallest block size.

### BACKGROUND

The High Efficiency Video Coding (HEVC) standard is developed under the joint video project of the ITU-T Video Coding Experts Group (VCEG) and the ISO/IEC Moving Picture Experts Group (MPEG) standardization organizations, and is especially with partnership known as the Joint Collaborative Team on Video Coding (JCT-VC).

In HEVC, one slice is partitioned into multiple coding tree units (CTU). The CTU is further partitioned into multiple coding units (CUs) to adapt to various local characteristics. HEVC supports multiple Intra prediction modes and for Intra coded CU, the selected Intra prediction mode is signalled. In addition to the concept of coding unit, the concept of prediction unit (PU) is also introduced in HEVC. Once the splitting of CU hierarchical tree is done, each leaf CU is further split into one or more prediction units (PUs) according to prediction type and PU partition. After prediction, the residues associated with the CU are partitioned into transform blocks, named transform units (TUs) for the transform process.

For prediction units, the partitioned block is predicted by Intra-picture prediction or Inter-picture prediction. The residual signal of the Intra- or Inter-picture prediction is transformed by a two-dimensional spatial transform (e.g. DCT, discrete cosine transform). The partitioned block shape for prediction and transform is always rectangular. There is a restriction of the block sizes. In HEVC, the smallest allowed block size for Intra-picture prediction is 4×4 for both luma and chroma blocks. For Inter-picture prediction, the smallest allowed block size is 4×8 or 8×4 for luma block, 2×4 or 4×2 for chroma block. The smallest allowed block size for transform is 4×4 for both the luma and chroma components

In HEVC, a transform skip mode is supported, where the transform is bypassed. This primarily improves compression for certain types of video content such as computer-generated images or graphics mixed with camera-view content (e.g., scrolling text). The transform skip mode can be applied to 4×4 block only according to the HEVC standard.

### SUMMARY

A method and apparatus of block partition for prediction process or transform process in video coding are disclosed. According to this method, whether a smallest allowed block size smaller than 4 is allowed is determined and information related to the decision is signalled in SPS (sequence parameter set), PPS (picture parameter set) or slice header. If the smallest allowed block size smaller than 4 is allowed, the current block is partitioned into one or more sub-blocks using a block size set including the smallest allowed block size. Each sub-block is not smaller than the smallest allowed block size. The smallest allowed block size is 2 in one embodiment.

If the current block corresponds to a 4×N or N×4 block (N≥4), the current block is allowed to be partitioned into multiple smaller sub-blocks not smaller than the smallest allowed block size. Information regarding whether the current block is partitioned into multiple smaller sub-blocks not smaller than the smallest allowed block size can be signalled. If N is equal to 4, the current block is allowed to be partitioned into two 4×2 or 2×4 sub-blocks, and each 4×2 or 2×4 sub-block is allowed to be partitioned into two 2×2 sub-blocks. Partition information regarding whether the 4×4 or 4×4 block is partitioned into two 4×2 or 2×4 sub-blocks and whether one 4×2 or 2×4 sub-block is partitioned into two 2×2 sub-blocks is signalled in a video bitstream.

If the prediction process is applied to the partitioned sub-blocks and if any sub-block has a sub-block width or height smaller than 4, prediction-related information can be signalled in a video bitstream. The prediction-related information may include the prediction mode corresponding to an Inter-prediction mode or an Intra-prediction mode, and the prediction-related information further includes one or more motion vectors if the prediction mode corresponding to the Inter-prediction mode. If the transform process is applied to the partitioned sub-blocks and if any sub-block has a sub-block width or height smaller than 4, transform-related information is signalled in a video bitstream. The transform-related information may include a transform type used or whether a transform skip mode is used. In one embodiment, the current block is partitioned according to a binary tree to generate said one or more sub-blocks.

According to another method, a threshold area is determined and transform skip mode is applied to the current block if the current block area of the current block is equal to or smaller than the threshold area. The block area is calculated by multiplying the block width with the block height. The threshold area can be signalled in SPS (sequence parameter set), PPS (picture parameter set) or slice header. In one embodiment, if the current block area of the current block is greater than the threshold area, transform process is applied to the current block. The threshold area can be 16 for the current block in an I slice and the threshold area can be 64 for the current block in a non-I slice.

### BRIEF DESCRIPTION OF THE DRAWINGS

FIG. 1 illustrates an exemplary flowchart for block partition with a block size set including a smallest allowed block size less than 4 in a decoder side according to an embodiment of the present invention.

FIG. 2 illustrates an exemplary flowchart for block partition with a block size set including a smallest allowed block size less than 4 in an encoder side according to an embodiment of the present invention.

FIG. 3 illustrates an exemplary flowchart for block partition, where transform skip mode is applied to a current block if the block area is smaller than or equal to the threshold area according to an embodiment of the present invention.

### DETAILED DESCRIPTION

The following description is of the best-contemplated mode of carrying out the invention. This description is made for the purpose of illustrating the general principles of the invention and should not be taken in a limiting sense. The scope of the invention is best determined by reference to the appended claims.

In one embodiment of the present application, the smallest allowed side length (i.e., block width or block height) of one block is set to smaller than 4. For example, a CU is partitioned according to a binary tree to generate one or more final partitioned blocks. The final partitioned block can be used for prediction process, transform process or both. In other words, the block width or block height for PU and/or TU can be smaller than 4 (e.g. 2). The related information can be signalled in high level syntax such as SPS (sequence parameter set), PPS (picture parameter set), or slice header.

For a luma or chroma block with block size equal to 4×N or N×4, the block can be further partitioned into smaller sub-blocks with size no smaller than the minimum allowed block size. N is a positive integer greater than or equal to 4. The subsequent prediction process and transform process are operated on the final partitioned sub-blocks.

Whether to partition a 4×N or N×4 block can be explicitly signalled in the bitstream. If a 4×N or N×4 block is partitioned, the particular partition shape can be explicitly signalled in the bitstream.

When prediction is operated on the final partitioned block with at least one side length smaller than 4, the prediction related information (if any) is explicitly signalled in the bitstream. The prediction related information may include whether Intra-picture or Inter-picture prediction used, the Intra-picture prediction mode, the motion vectors, and so on.

When transform is operated on the final partitioned block with at least one side length smaller than 4, the transform related information (if any) is explicitly signalled in the bitstream. The transform related information may include which transform type is used, whether the transform skip mode is used.

According to an embodiment of the present invention, the transform skip mode can be applied for the blocks with area no larger than a particular threshold, where the area is calculated by multiplying block width by block height for a rectangle. For each block satisfying this condition (i.e., area<=threshold), a flag can be signalled to indicate whether the transform skip is used. The threshold can be different for different slice types, such as different thresholds for Intra-picture and Inter-picture prediction types. The particular threshold can be signalled in high level syntax such as SPS (sequence parameter set), PPS (picture parameter set), or slice header. The used feature (i.e., area) can also be replaced by other similar features such as perimeter.

In an embodiment of the present invention, the smallest allowed side length of one block is set to 2, for an I slice. The transform skip mode can be applied for the blocks with area no larger than 16 for I slice, and with area no larger than 64 for non-I (i.e., B and P) slices. That information is signalled in the SPS.

In the I slice, for a block with size equal to 4×4, it can be partitioned into two 2×4 or 4×2 sub-blocks, and each sub-block can be further partitioned into two 2×2 sub-blocks. Those partitioning information can be explicitly signalled in the bitstream. Assuming the final-partitioned blocks are four 2×2 blocks, the prediction process and transform process can be operated for each 2×2 block.

The Intra-picture prediction mode for each 2×2 block can be explicitly signalled. The transform skip mode can be applied for each 2×2 blocks. The information regarding whether to apply to transform skip mode for each 2×2 block can be signalled in the bitstream.

In another embodiment of the invention, the smallest allowed side length of a block used for transform is set to 2 for all slice types. For each final partitioned 2×N block, the transform related information can be explicitly signalled and a transform can be applied accordingly. The transform related information includes whether the transform skip mode is applied.

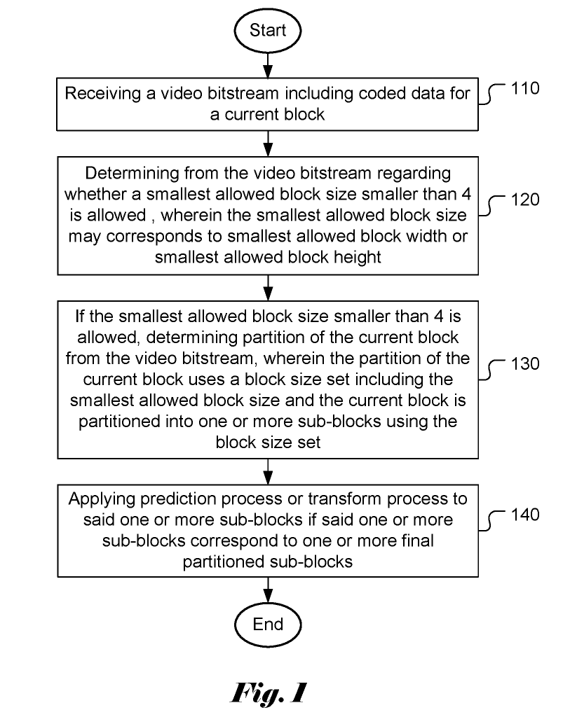

FIG. 1 illustrates an exemplary flowchart for block partition with a block size set including a smallest allowed block size less than 4 in a decoder side according to an embodiment of the present invention. According to this method, a video bitstream including coded data for a current block is received in step 110. Whether a smallest allowed block size smaller than 4 is allowed is determined from the video bitstream in step 120, where the smallest allowed block size corresponds to a smallest allowed block width or a smallest allowed block height. If the smallest allowed block size smaller than 4 is allowed, partition of the current block from the video bitstream is determined in step 130, where the partition of the current block uses a block size set including the smallest allowed block size and the current block is partitioned into one or more sub-blocks using the block size set. Prediction process or transform process is then applied to said one or more sub-blocks in step 140 if said one or more sub-blocks correspond to one or more final partitioned sub-blocks.

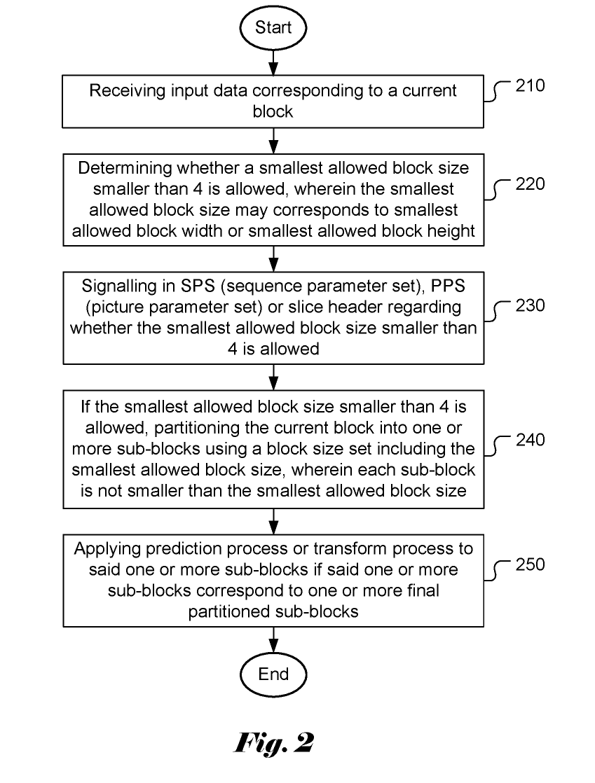

FIG. 2 illustrates an exemplary flowchart for block partition with a block size set including a smallest allowed block size less than 4 in an encoder side according to an embodiment of the present invention. According to this method, input data corresponding to a current block is received in step 210. Whether a smallest allowed block size smaller than 4 is allowed is determined in step 220, where the smallest allowed block size corresponds to a smallest allowed block width or a smallest allowed block height. Information regarding whether the smallest allowed block size smaller than 4 is allowed is signalled in SPS (sequence parameter set), PPS (picture parameter set) or slice header in step 230. If the smallest allowed block size smaller than 4 is allowed, the current block is partitioned into one or more sub-blocks using a block size set including the smallest allowed block size in step 240, where each sub-block is not smaller than the smallest allowed block size. Prediction process or transform process is applied to said one or more sub-blocks if said one or more sub-blocks are corresponding to one or more final partitioned sub-blocks (i.e., generated after final partition) in step 250.

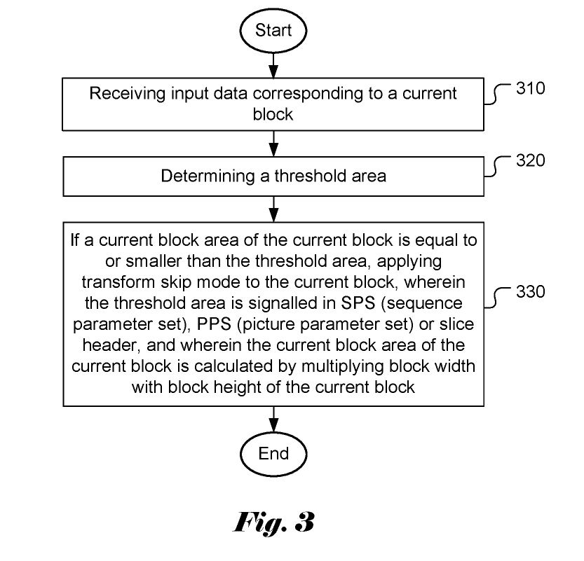

FIG. 3 illustrates an exemplary flowchart for block partition, where transform skip mode is applied to a current block if the block area is smaller than or equal to the threshold area according to an embodiment of the present invention. According to this method, input data corresponding to a current block is received in step 310. A threshold area is determined in step 320, wherein the threshold area can be signalled in SPS (sequence parameter set), PPS (picture parameter set) or slice header. If current block area of the current block is equal to or smaller than the threshold area, transform skip mode is applied to the current block in step 330. The current block area of the current block is calculated by multiplying block width with block height of the current block.

The flowcharts shown are intended to illustrate an example of video coding according to the present invention. A person skilled in the art may modify each step, re-arranges the steps, split a step, or combine steps to practice the present invention without departing from the spirit of the present invention. In the disclosure, specific syntax and semantics have been used to illustrate examples to implement embodiments of the present invention. A skilled person may practice the present invention by substituting the syntax and semantics with equivalent syntax and semantics without departing from the spirit of the present invention.

The above description is presented to enable a person of ordinary skill in the art to practice the present invention as provided in the context of a particular application and its requirement. Various modifications to the described embodiments will be apparent to those with skill in the art, and the general principles defined herein may be applied to other embodiments. Therefore, the present invention is not intended to be limited to the particular embodiments shown and described, but is to be accorded the widest scope consistent with the principles and novel features herein disclosed. In the above detailed description, various specific details are illustrated in order to provide a thorough understanding of the present invention. Nevertheless, it will be understood by those skilled in the art that the present invention may be practiced.

Embodiment of the present invention as described above may be implemented in various hardware, software codes, or a combination of both. For example, an embodiment of the present invention can be one or more circuit circuits integrated into a video compression chip or program code integrated into video compression software to perform the processing described herein. An embodiment of the present invention may also be program code to be executed on a Digital Signal Processor (DSP) to perform the processing described herein. The invention may also involve a number of functions to be performed by a computer processor, a digital signal processor, a microprocessor, or field programmable gate array (FPGA). These processors can be configured to perform particular tasks according to the invention, by executing machine-readable software code or firmware code that defines the particular methods embodied by the invention. The software code or firmware code may be developed in different programming languages and different formats or styles. The software code may also be compiled for different target platforms. However, different code formats, styles and languages of software codes and other means of configuring code to perform the tasks in accordance with the invention will not depart from the spirit and scope of the invention.

The invention may be embodied in other specific forms without departing from its spirit or essential characteristics. The described examples are to be considered in all respects only as illustrative and not restrictive. The scope of the invention is therefore, indicated by the appended claims rather than by the foregoing description. All changes which come within the meaning and range of equivalency of the claims are to be embraced within their scope.

1. A method of block partition for prediction process or transform process in video decoding, the method comprising:
receiving a video bitstream including coded data for a current block;
determining from the video bitstream regarding whether a smallest allowed block size smaller than 4 is allowed, wherein the smallest allowed block size corresponds to a smallest allowed block width or a smallest allowed block height;
if the smallest allowed block size smaller than 4 is allowed, determining partition of the current block from the video bitstream, wherein the partition of the current block uses a block size set including the smallest allowed block size and the current block is partitioned into one or more sub-blocks using the block size set; and
applying prediction process or transform process to said one or more sub-blocks if said one or more sub-blocks correspond to one or more final partitioned sub-blocks.

2. The method of claim 1, wherein the smallest allowed block size is 2.

3. The method of claim 1, wherein if the current block corresponds to a 4×N or N×4 block, information regarding whether the current block is partitioned into multiple smaller sub-blocks not smaller than the smallest allowed block size is determined from the video bitstream, wherein N is greater than or equal to 4.

4. The method of claim 3, wherein if N is equal to 4, the current block is partitioned into two 4×2 or 2×4 sub-blocks according to partition information signalled in the video bitstream.

5. The method of claim 4, wherein each 4×2 or 2×4 sub-block is partitioned into two 2×2 sub-blocks according to the partition information signalled in the video bitstream.

6. The method of claim 1, wherein if the prediction process is applied to said one or more sub-blocks and if any sub-block has a sub-block width or height smaller than 4, prediction-related information is signalled in the video bitstream.

7. The method of claim 6, wherein the prediction-related information includes a prediction mode corresponding to an Inter-prediction mode or an Intra-prediction mode, and wherein the prediction-related information further includes one or more motion vectors if the prediction mode corresponds to the Inter-prediction mode.

8. The method of claim 1, wherein if the prediction process is applied to said one or more sub-blocks and if any sub-block has a sub-block width or height smaller than 4, transform-related information is signalled in the video bitstream.

9. The method of claim 8, wherein the transform-related information includes a transform type used or whether a transform skip mode is used.

10. The method of claim 1, wherein the current block is partitioned according to a binary tree to generate said one or more sub-blocks.

11. An apparatus for block partition for prediction process or transform process in video decoding, the apparatus comprising one or more electronic circuits or processors configured to:
receive a video bitstream including coded data for a current block;
determining from the video bitstream regarding whether a smallest allowed block size smaller than 4 is allowed, wherein the smallest allowed block size corresponds to a smallest allowed block width or a smallest allowed block height;
if the smallest allowed block size smaller than 4 is allowed, determine partition of the current block from the video bitstream, wherein the partition of the current block uses a block size set including the smallest allowed block size and the current block is partitioned into one or more sub-blocks using the block size set; and
apply prediction process or transform process to said one or more sub-blocks if said one or more sub-blocks correspond to one or more final partitioned sub-blocks.

12. (canceled)

13. (canceled)

14. (canceled)

15. (canceled)

16. (canceled)

17. (canceled)

18. (canceled)

19. (canceled)

20. (canceled)

21. (Canceled)

22. (canceled)

23. A method of block partition for transform process in video coding, the method comprising:
receiving input data corresponding to a current block;
determining a threshold area;
if a current block area of the current block is equal to or smaller than the threshold area, applying transform skip mode to the current block, wherein the threshold area is signalled in SPS (sequence parameter set), PPS (picture parameter set) or slice header; and
wherein the current block area of the current block is calculated by multiplying block width with block height of the current block.

24. The method of claim 23, wherein if the current block area of the current block is greater than the threshold area, applying transform process to the current block.

25. The method of claim 23, wherein the threshold area is 16 for the current block in an I slice and wherein the threshold area is 64 for the current block in a non-I slice.

26. An apparatus for block partition for transform process in video coding, the apparatus comprising one or more electronic circuits or processors configured to:
receive input data corresponding to a current block;
determine a threshold area;
if a current block area of the current block is equal to or smaller than the threshold area, apply transform skip mode to the current block, wherein the threshold area is signalled in SPS (sequence parameter set), PPS (picture parameter set) or slice header; and
wherein the current block area of the current block is calculated by multiplying block width with block height of the current block.
